(19) United States
(12) Patent Application Publication
(10) Pub. No.: US 2013/0272168 A1
(43) Pub. Date: Oct. 17, 2013

(54) REDUCING TRANSIENT EFFECTS WHEN CHANGING TRANSMIT CHAIN POWER

(71) Applicant: QUALCOMM INCORPORATED, San Diego, CA (US)

(72) Inventors: Ketan HUMNBADKAR, San Diego, CA (US); Brian Clarke BANISTER, San Diego, CA (US); Mingxia CHENG, San Diego, CA (US); Wei-Hao LIN, San Diego, CA (US); Jong Hyeon PARK, San Jose, CA (US)

(73) Assignee: QUALCOMM INCORPORATED, San Diego, CA (US)

(21) Appl. No.: 13/781,609

(22) Filed: Feb. 28, 2013

Related U.S. Application Data
(60) Provisional application No. 61/624,195, filed on Apr. 13, 2012.

(51) Int. Cl. H04J 3/16

(52) U.S. Cl. CPC H04J 3/16
USPC 370/278

(57) ABSTRACT

A method, an apparatus, and a computer program product for a wireless communication device are provided. The apparatus determines a receive timing for receiving through at least one receive chain element. The apparatus determines a time to turn on/off at least one transmit chain element based on the determined receive timing and based on receiver impact to the at least one receive chain element caused by turning on/off the at least one transmit chain element. The apparatus reduces receiver impact to the at least one receive chain element by turning on/off the at least one transmit chain element at the determined time.

### CROSS-REFERENCE TO RELATED APPLICATION(S)

This application claims the benefit of U.S. Provisional Application Ser. No. 61/624,195, entitled “REDUCING TRANSIENT EFFECTS WHEN CHANGING TRANSMIT CHAIN POWER” and filed on Apr. 13, 2012, which is expressly incorporated by reference herein in its entirety.

### BACKGROUND

1. Field

The present disclosure relates generally to communication systems, and more particularly, to reducing transient effects when changing transmit chain power.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the UL, and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

In an aspect of the disclosure, a method, a computer program product, and an apparatus are provided. In a first configuration, the apparatus determines a receive timing for receiving through at least one receive chain element, determines a time to turn on/off at least one transmit chain element based on the determined receive timing and based on receiver impact to the at least one receive chain element caused by turning on/off the at least one transmit chain element, and reduces receiver impact to the at least one receive chain element by turning on/off the at least one transmit chain element at the determined time.

In an aspect of the disclosure, a method, a computer program product, and an apparatus are provided. In a second configuration, the apparatus determines a receive timing for receiving through at least one receive chain element. The apparatus determines a time to adjust a transmit gain based on the determined receive timing and based on receiver impact to the at least one receive chain element caused by adjusting the transmit gain. The apparatus reduces receiver impact to the at least one receive chain element by adjusting the transmit gain at the determined time.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control planes.

FIG. 6 is a diagram illustrating an example of an evolved Node B and user equipment in an access network.

FIG. 7 is a diagram for illustrating an exemplary method.

FIG. 8 is a flow chart of a first method of a wireless communication device.

FIG. 9 is a flow chart of a second method of a wireless communication device.

FIG. 10 is a flow chart of a third method of a wireless communication device.

FIG. 11 is a flow chart of a fourth method of a wireless communication device.

FIG. 12 is a conceptual data flow diagram illustrating the data flow between different modules/means/components in an exemplary apparatus.

FIG. 13 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

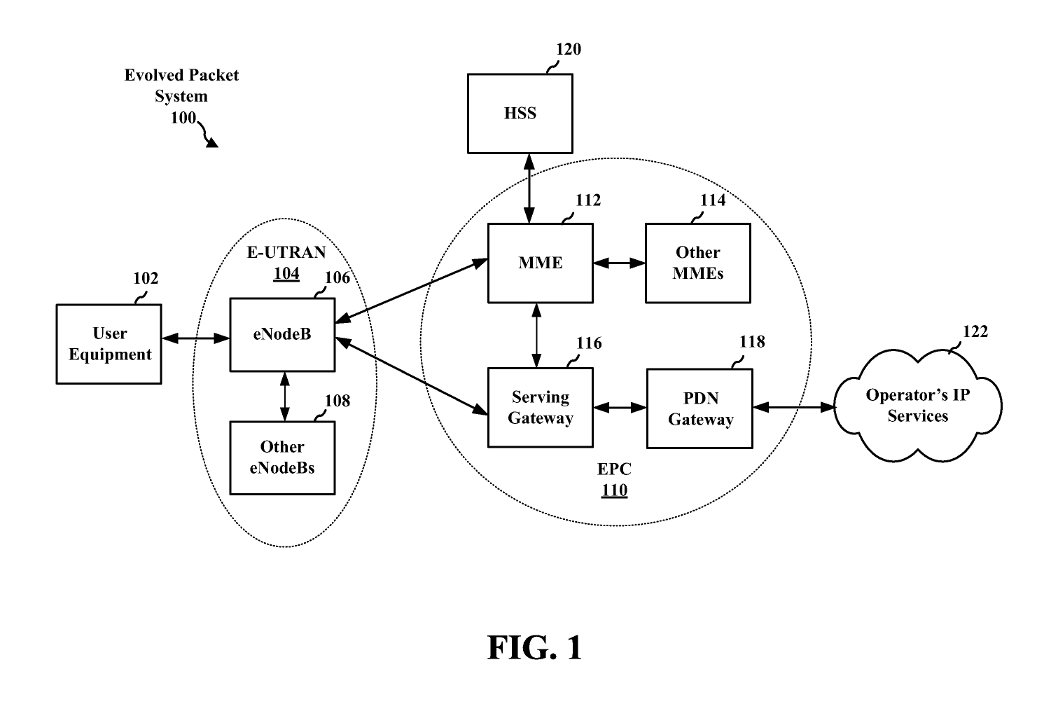

FIG. 1 is a diagram illustrating an LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control planes protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an 51 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, the Intranet, an IP Multimedia Subsystem (IMS), and a PS Streaming Service (PSS).

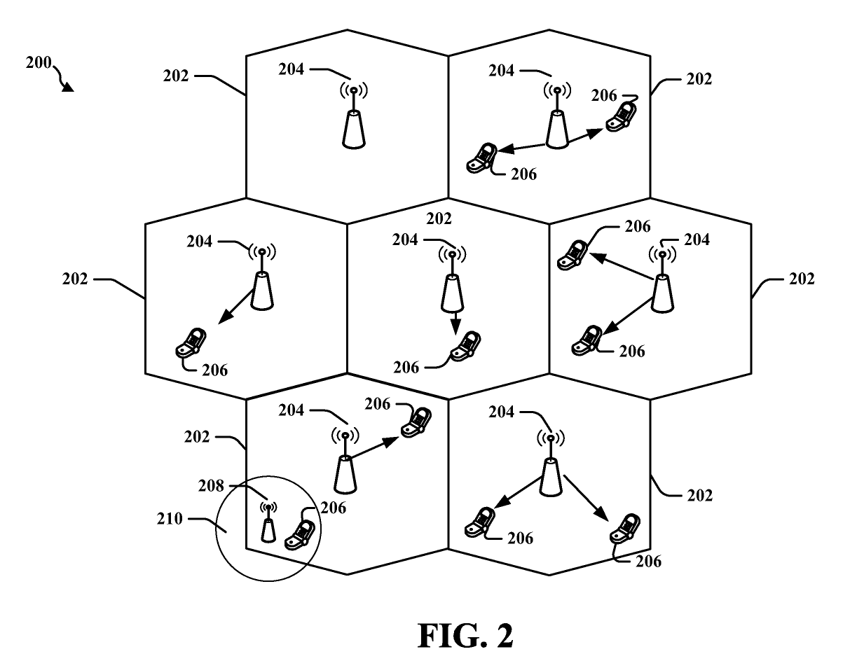

FIG. 2 is a diagram illustrating an example of an access network 200 in an LTE network architecture. In this example, the access network 200 is divided into a number of cellular regions (cells) 202. One or more lower power class eNBs 208 may have cellular regions 210 that overlap with one or more of the cells 202. The lower power class eNB 208 may be a femto cell (e.g., home eNB (HeNB)), pico cell, micro cell, or remote radio head (RRH). The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

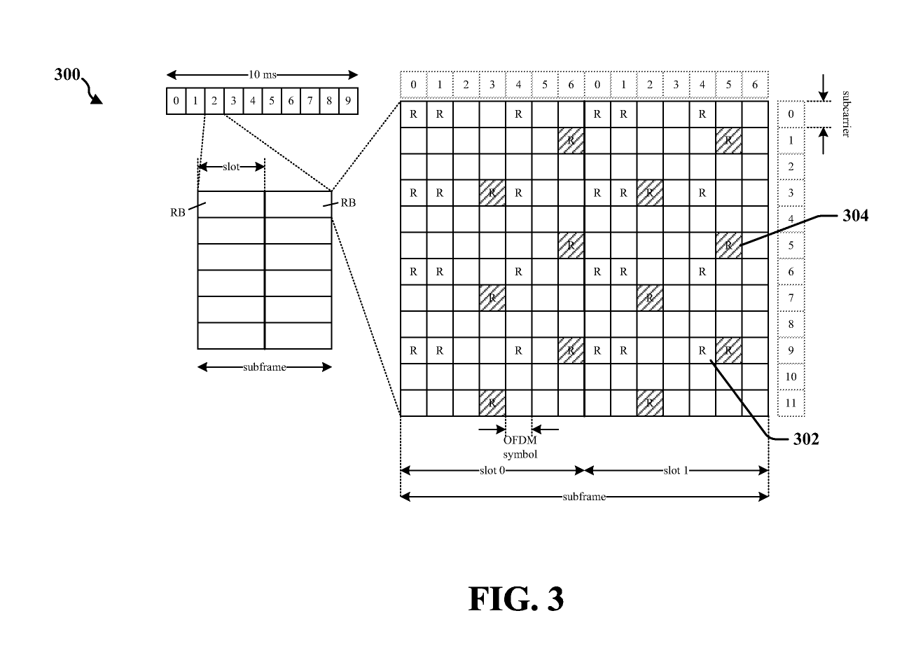

FIG. 3 is a diagram 300 illustrating an example of a DL frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

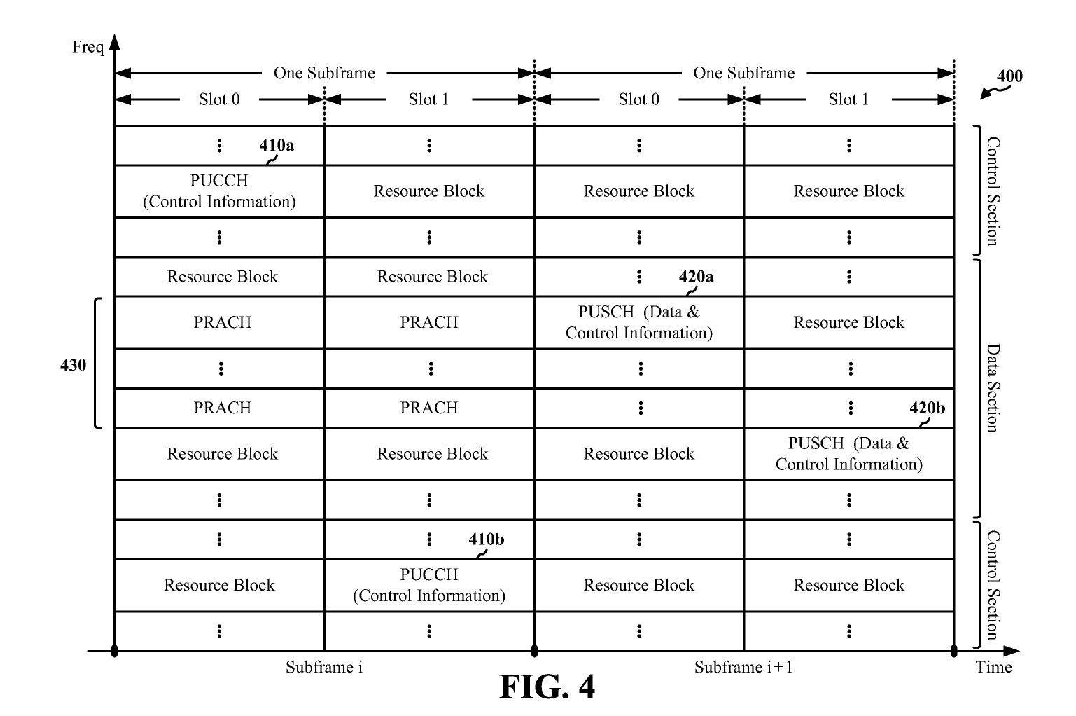

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

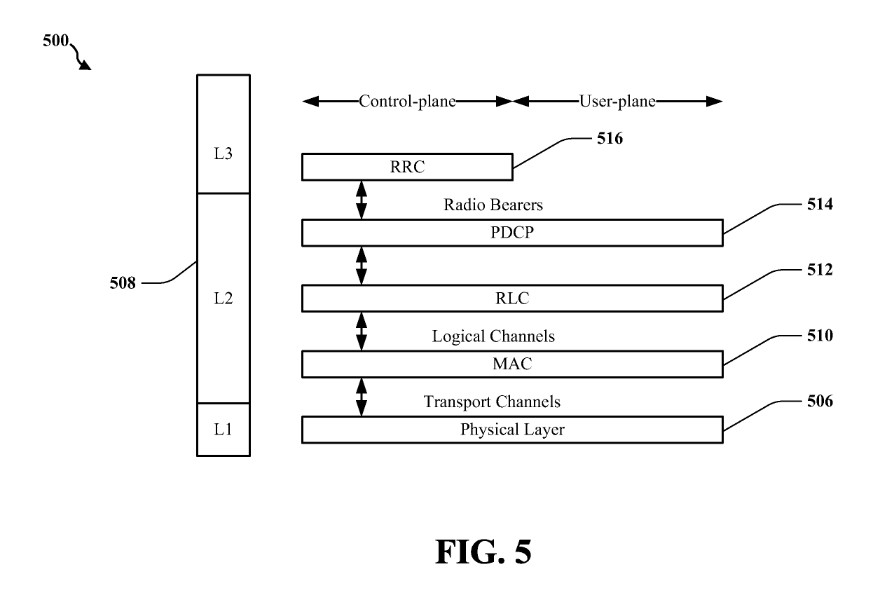

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

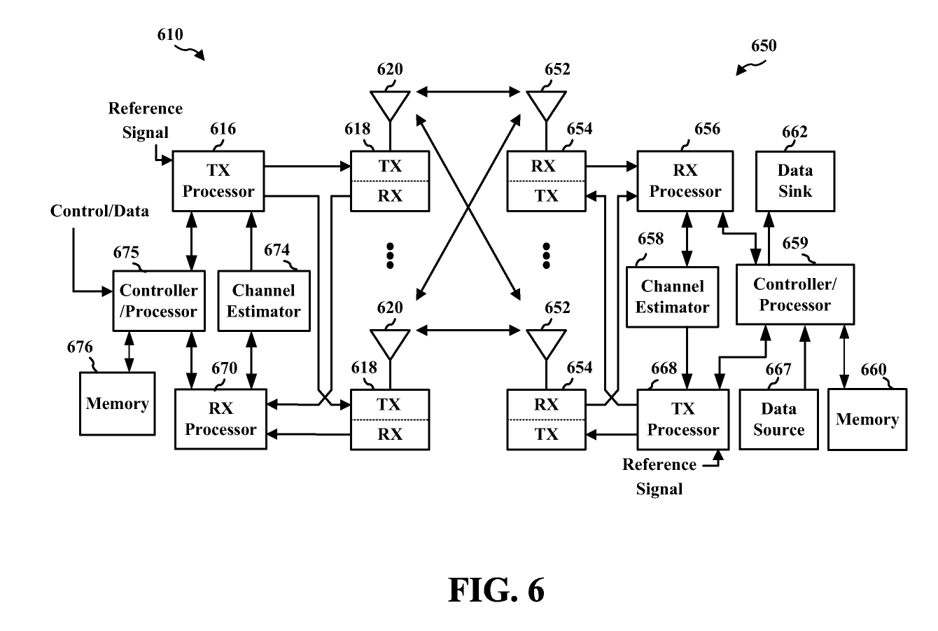

FIG. 6 is a block diagram of an eNB 610 in communication with a UE 650 in an access network. In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The transmit (TX) processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receive (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the control/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations.

In LTE, when there are no scheduled UL transmissions, the UE may shut off the transmit chain. Shutting off and turning on the transmit chain may cause an abrupt change in the current drawn from the power supply. The abrupt change in the current drawn from the power supply may create a transient voltage upward/downward spike on the power supply as the power supply tries to regulate at the new load current. The transient voltage spike may affect the DL receiver chain, which is sensitive to the transient voltage spike. The transient voltage spike on the receiver chain may degrade DL throughput performance. As such, methods are needed for reducing the transient voltage effects when changing the transmit chain power.

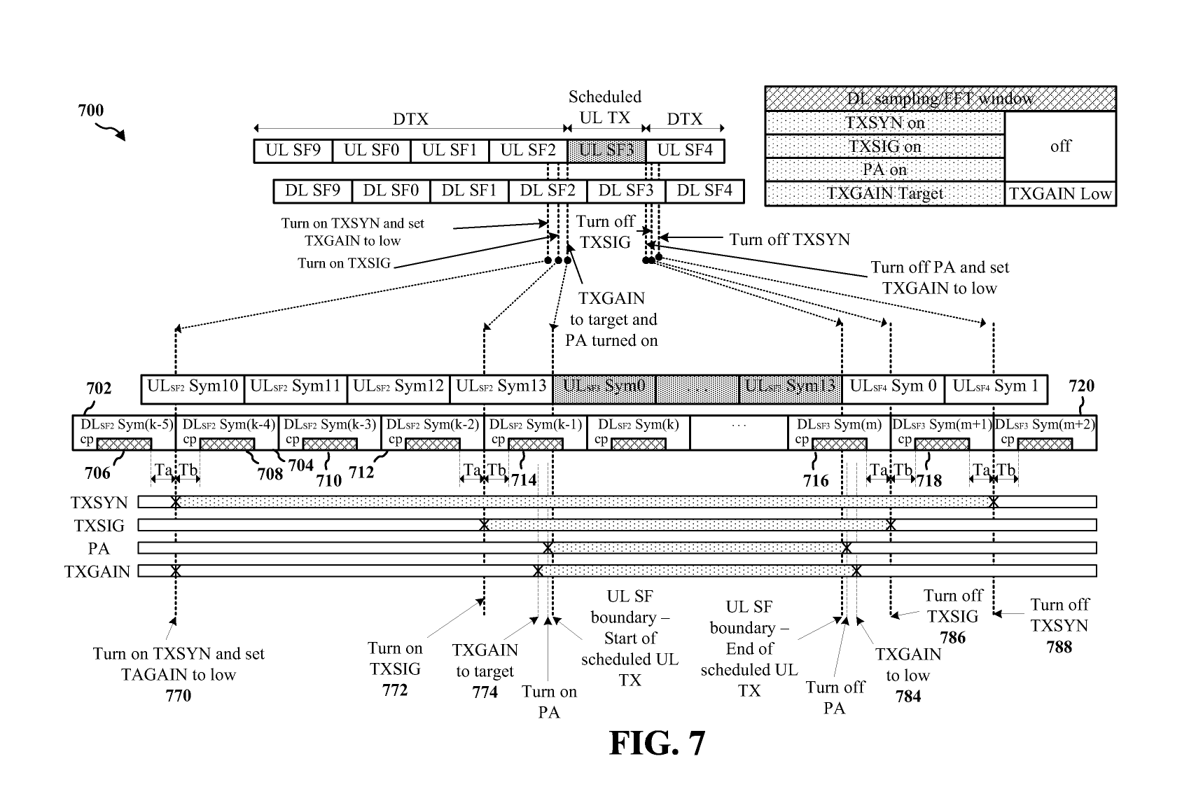

FIG. 7 is a diagram 700 for illustrating an exemplary method. According to a first exemplary method, a UE determines a receive timing for receiving through at least one receive chain element. In addition, the UE determines when to turn on/off at least one transmit chain element based on the determined receive timing and based on reducing receiver impact to the at least one receive chain element caused by turning on/off the at least one transmit chain element. According to a second exemplary method, a UE determines a receive timing for receiving through at least one receive chain element. In addition, the UE determines when to adjust a transmit gain based on the determined receive timing and based on reducing receiver impact to the at least one receive chain element caused by adjusting the transmit gain. A UE may perform the first exemplary method, the second exemplary method, or both the first and second exemplary methods. The exemplary methods apply to both TDD and FDD systems. An FDD system is illustrated in FIG. 7. Upon receiving an UL grant, a UE has a scheduled UL transmission in a particular subframe (e.g., subframe 3 as illustrated in FIG. 7) and turns on a transmit synthesizer (TXSYN) and a transmit signal path (TXSIG) in a preceding subframe (e.g., subframe 2 as illustrated in FIG. 7) and turns off the transmit synthesizer and transmit signal path in a subsequent subframe (e.g., subframe 4 as illustrated in FIG. 7). The UE determines to turn on/off the transmit synthesizer and the transmit signal path between sampling/FFT windows of adjacent symbols (e.g., OFDM symbols, SC-FDMA symbols) in the preceding and subsequent subframes.

In particular, as shown in FIG. 7, the UE determines to turn on 770 the transmit synthesizer at an interface between OFDM symbol 702 and OFDM symbol 704. Assuming there are 14 OFDM symbols within a 1 ms subframe (see FIG. 3), each OFDM symbol extends approximately 71.4 us. Turning on the transmit synthesizer may cause a transient voltage spike that lasts for about 15-20 us, with a peak occurring after about 4 us. The UE determines to turn on the transmit synthesizer at the interface between OFDM symbols 702, 704 so that a peak of the transient voltage spike occurs within the cyclic prefix (CP) of the OFDM symbol 704 and within time T_{b} after the start of the OFDM symbol 704. Turning on the transmit synthesizer at such a time reduces the effect of the transient voltage spike on the DL receiver chain while the DL receiver chain receives and processes the signal received within the sampling/FFT window 708 of the OFDM symbol 704. In another configuration, the UE may determine to turn on the transmit synthesizer within a time Tₐ before the end of the OFDM symbol 702. By turning on the transmit synthesizer approximately immediately after (e.g., immediately after) the sampling/FFT window 706, the effect of the transient voltage spike on the DL receiver chain is reduced, as the transient voltage spike will have time Tₐ+T_{b} to settle before the DL receiver chain receives and processes the signal received within the sampling/FFT window 708 of the OFDM symbol 704. In yet another configuration, the UE may determine to turn on the transmit synthesizer during the sampling/FFT window 706 if the effect of the transient voltage spike on the DL receiver chain is improved by turning on the transmit synthesizer during the sampling/FFT window 706 rather than after the sampling/FFT window 706.

As shown in FIG. 7, the UE determines to turn off 788 the transmit synthesizer between sampling/FFT windows of the OFDM symbols 718, 720 in order to reduce the effect of the transient voltage spike on the DL receiver chain while the DL receiver chain receives and processes the signals received within the sampling/FFT windows of the OFDM symbols 718, 720. The UE may reduce the size/amplitude of the transient voltage spike by turning on/off each element in the UL transmit chain at different times and aligning each power change between sampling/FFT windows of different OFDM symbols. For example, as shown in FIG. 7, the transmit signal path is turned on 772 at an interface between OFDM symbols 712, 714 and is turned off 786 at an interface between OFDM symbols 716, 718.

In FIG. 7, changes in power to the power amplifier are not aligned between the sampling/FFT windows of two OFDM symbols. However, changes in power to the power amplifier may also be made at such time that an effect of the transient voltage spike due to the change in power to the power amplifier is reduced on the DL receiver chain while the DL receiver chain receives and processes the signals received within the sampling/FFT windows of the OFDM symbols. Similarly, changes to the transmit gain may also be made at such time that an effect of the transient voltage spike due to the change in the transmit gain is reduced on the DL receiver chain while the DL receiver chain receives and processes the signals received within the sampling/FFT windows of the OFDM symbols. For example, assuming the transmit signal path is turned on between the sampling/FFT windows of the OFDM symbols 710, 712, the transmit gain may be increased from low to high (i.e., to target) between the sampling/FFT windows of the OFDM symbols 712, 714 instead of at 774 during the sampling/FFT window of the OFDM symbol 714. For another example, assuming the transmit signal path is turned off between the sampling/FFT windows of the OFDM symbols 718, 720 and the transmit synthesizer is turned off following the sampling/FFT window of the OFDM symbol 720, the transmit gain may be decreased from high to low between the sampling/FFT windows of the OFDM symbols 716, 718 instead of at 784 during the sampling/FFT window of the OFDM symbol 716.

In one configuration, the transmit gain may be adjusted stepwise in consecutive OFDM symbols between corresponding sampling/FFT windows. For example, assuming the transmit signal path is turned on between the sampling/FFT windows of the OFDM symbols 708, 710, the transmit gain may be increased from low to mid level between the sampling/FFT windows of the OFDM symbols 710, 712 and from mid level to high between the sampling/FFT windows of the OFDM symbols 712, 714. By adjusting the transmit gain stepwise between sampling/FFT windows of a plurality of OFDM symbols (e.g., consecutive OFDM symbols), the size/amplitude of the transient voltage spike for each adjustment is reduced and therefore an effect of the transient voltage spike on the DL receiver chain is reduced while the DL receiver chain receives and processes the signals received within the sampling/FFT windows of the OFDM symbols.

The UE may make continued adjustments to the time at which the UE turns on/off transmit chain elements based on DL timing adjustments. That is, a UE may receive a DL timing adjustment and adjust when to turn on/off at least one transmit chain element based on the adjusted DL timing. The UE may also adjust when and how the transmit gain is adjusted based on DL timing adjustments. The UE may adjust when to turn on/off at least one transmit chain element and/or adjust when and how the transmit gain is adjusted based on DL timing adjustments in both TDD and FDD systems.

As described supra, a UE may determine a receive timing for receiving through at least one receive chain element. Further, the UE may determine when to turn on/off at least one transmit chain element based on the determined receive timing and based on reducing receiver impact to the at least one receive chain element caused by turning on/off the at least one transmit chain element. Alternatively or in addition, the UE may determine when to adjust a transmit gain based on the determined receive timing and based on reducing receiver impact to the at least one receive chain element caused by adjusting the transmit gain. The receive timing may be a DL timing and the at least one transmit chain element may be at least one UL transmit chain element, such as when the UE is in wireless wide area network (WWAN) communication with an eNB. The receive timing may be a timing with another UE, such as when the UE is in peer-to-peer communication with another UE. Rather than turn on/off a transmit chain element, the UE may turn on/off other modules based on the receive timing. Furthermore, the UE may adjust a power based on the receive timing rather than actually turn on/off power. As such, generally, a UE may determine a receive timing and adjust power to a module based on the receive timing and based on reducing receiver impact to the module caused by the adjustment. The UE may adjust the power by turning on/off the power to the module or by changing an amount of power applied to the module.

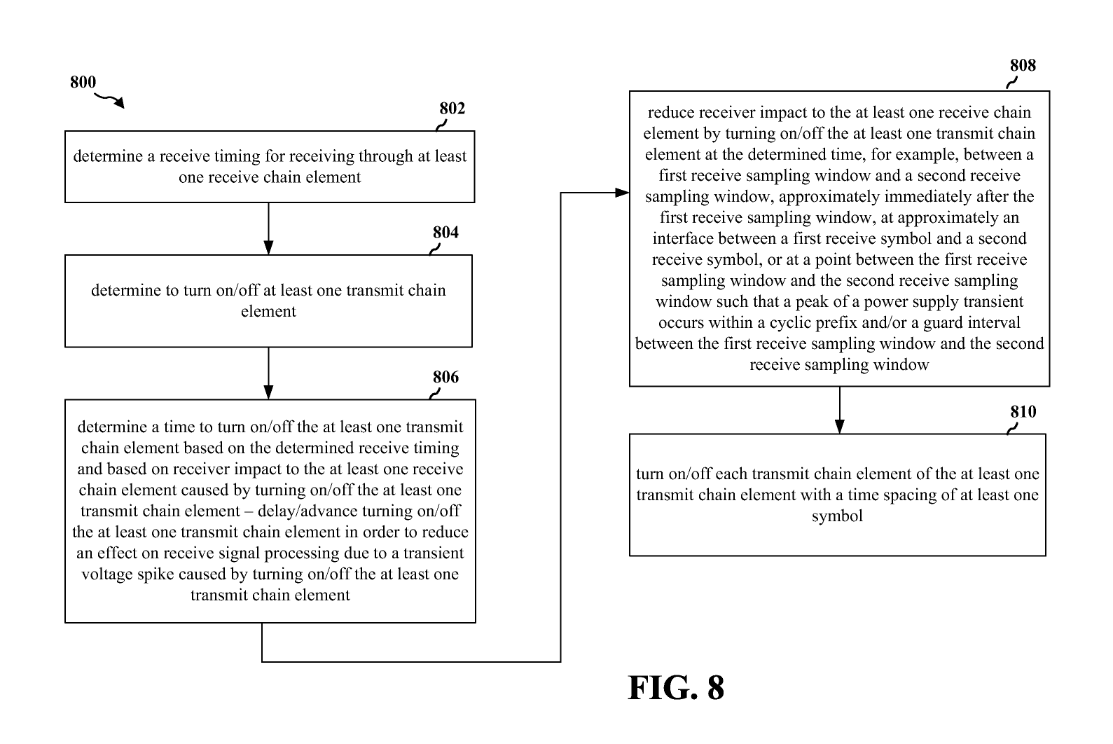

FIG. 8 is a flow chart 800 of a first method of a wireless communication device. The method may be performed by a UE. In step 802, a UE determines a receive timing for receiving through at least one receive chain element. In step 804, the UE determines to turn on/off at least one transmit chain element. In step 806, the UE determines a time to turn on/off the at least one transmit chain element based on the determined receive timing and based on receiver impact (e.g., reducing receiving impact) to the at least one receive chain element caused by turning on/off the at least one transmit chain element. In step 806, the UE may determine the time to turn on/off the at least one transmit chain element by delaying/advancing turning on/off the at least one transmit chain element in order to reduce an effect on receive signal processing due to a transient voltage spike during a receive sampling window caused by turning on/off the at least one transmit chain element. In step 808, the UE reduces receiver impact to the at least one receive chain element by turning on/off the at least one transmit chain element at the determined time. The UE may delay/advance turning on/off the at least one transmit chain element until a time between a first receive sampling window and a second receive sampling window. The time between the first receive sampling window and the second receive sampling window may include at least one of a CP or a guard interval. The first receive sampling window may be within a first receive symbol (e.g., OFDM symbol, SC-FDMA symbol) and the second receive sampling window may be within a second receive symbol (e.g., OFDM symbol, SC-FDMA symbol). The UE may turn on/off the at least one transmit chain element at approximately an interface (e.g., at an interface) between the first receive symbol and the second receive symbol. The UE may turn on/off the at least one transmit chain element approximately immediately after (e.g., immediately after) the first receive sampling window. The UE may turn on/off the at least one transmit chain element at a point such that a peak of a power supply transient occurs within a CP or guard interval between the first receive sampling window and the second receive sampling window. In step 810, the UE may turn on/off each transmit chain element of the at least one transmit chain element with a time spacing of at least one symbol.

For example, referring to FIG. 7, the UE turns on the transmit synthesizer at approximately an interface between the OFDM symbol 706 and the OFDM symbol 708 and turns on the transmit signal path at approximately an interface between the OFDM symbol 712 and the OFDM symbol 714. In addition, the UE turns off the transmit signal path at approximately an interface between the OFDM symbol 716 and the OFDM symbol 718 and turns off the transmit synthesizer at approximately an interface between the OFDM symbol 718 and the OFDM symbol 720.

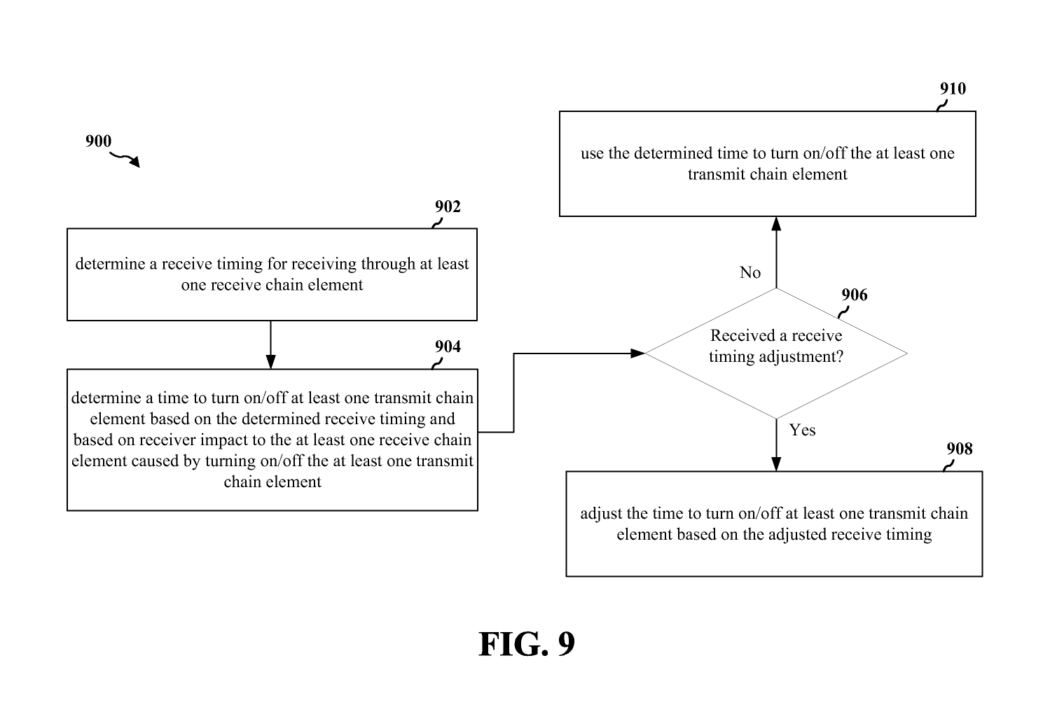

FIG. 9 is a flow chart 900 of a second method of a wireless communication device. The method may be performed by a UE. In step 902, a UE determines a receive timing for receiving through at least one receive chain element. In step 904, the UE determines a time to turn on/off at least one transmit chain element based on the determined receive timing and based on receiver impact (e.g., reducing receiver impact) to the at least one receive chain element caused by turning on/off the at least one transmit chain element. In step 906, the UE determines whether a receive timing adjustment has been received. If a receive timing adjustment has been received, in step 908, the UE adjusts the time to turn on/off at least one transmit chain element based on the adjusted receive timing. If a receive timing adjustment has not been received, in step 910, the UE uses the determined time in step 904 to turn on/off the at least one transmit chain element.

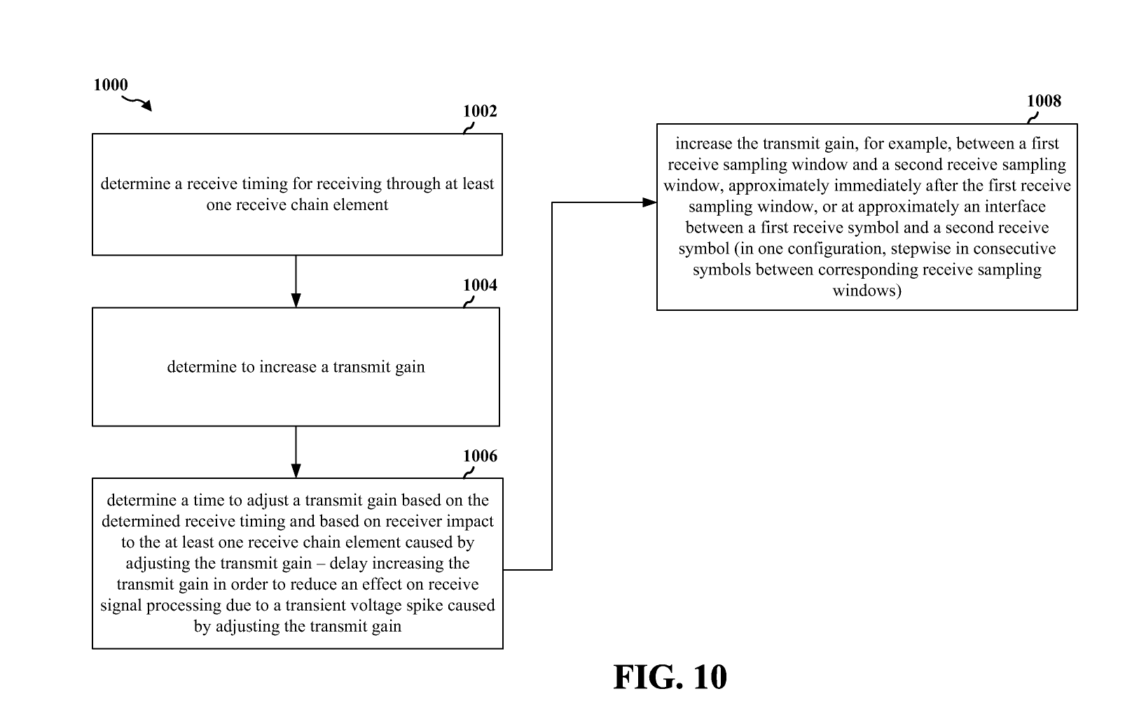

FIG. 10 is a flow chart 1000 of a third method of a wireless communication device. The method may be performed by a UE. In step 1002, a UE determines a receive timing for receiving through at least one receive chain element. In step 1004, the UE determines to increase a transmit gain. In step 1006, the UE determines a time to adjust a transmit gain based on the determined receive timing and based on receiver impact (e.g., reducing receiver impact) to the at least one receive chain element caused by adjusting the transmit gain. The UE may determine the time to adjust the transmit gain by delaying increasing the transmit gain in order to reduce an effect on receive signal processing due to a transient voltage spike during a receive sampling window caused by increasing the transmit gain. The UE may delay the transmit gain increase until a time between two receive sampling windows. In step 1008, the UE increases the transmit gain. The UE may increase the transmit gain between a first receive sampling window and a second receive sampling window. The UE may increasing the transmit gain approximately immediately after the first receive sampling window. The first receive sampling window may be within a first receive symbol (e.g., OFDM symbol, SC-FDMA symbol) and the second receive sampling window may be within a second receive symbol (e.g., OFDM symbol, SC-FDMA symbol). The UE may increase the transmit gain at approximately an interface between the first receive symbol and the second receive symbol. The UE may increase the transmit gain stepwise in consecutive symbols between corresponding receive sampling windows.

For example, as discussed supra in relation to FIG. 7, assuming the transmit signal path is already turned on, a UE may set the transmit gain to high at approximately an interface between the OFDM symbol 712 and the OFDM symbol 714, or may increase the transmit gain stepwise in consecutive OFDM symbols such as at approximately an interface between the OFDM symbol 710 and the OFDM symbol 712 and again at approximately an interface between the OFDM symbol 712 and the OFDM symbol 714. The UE may alternatively or additionally determine to decrease the transmit gain between sampling/FFT windows of adjacent OFDM symbols. Assuming the transmit signal path is still turned on, the UE may set the transmit gain to low at approximately an interface between the OFDM symbol 716 and the OFDM symbol 718.

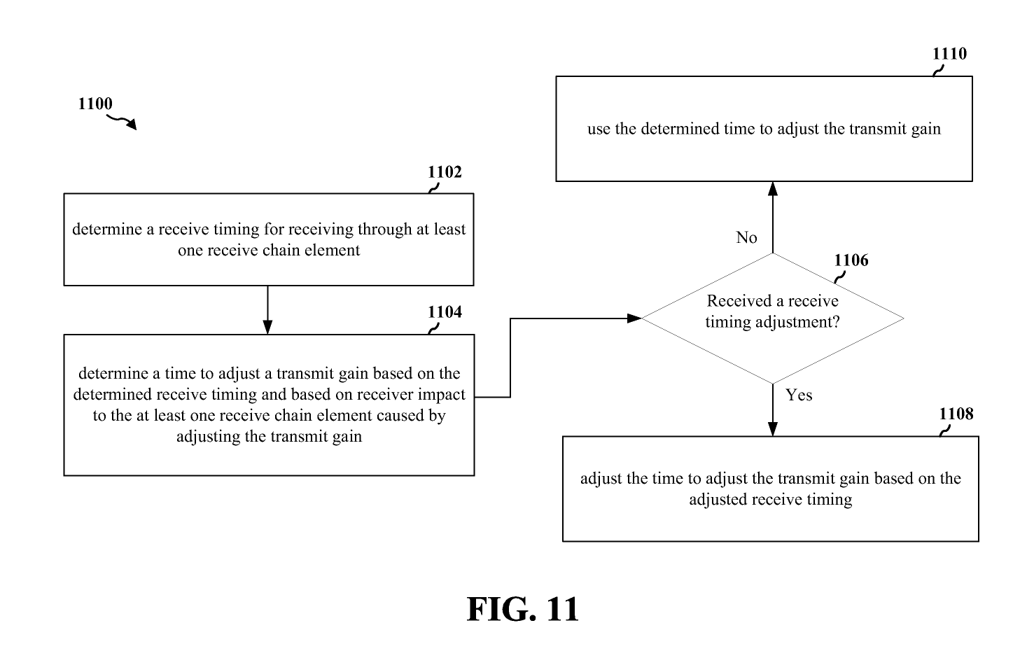

FIG. 11 is a flow chart 1100 of a fourth method of a wireless communication device. The method may be performed by a UE. In step 1102, a UE determines a receive timing for receiving through at least one receive chain element. In step 1104, the UE determines a time to adjust (increase and/or decrease) a transmit gain based on the determined receive timing and based on receiver impact (e.g., reducing receiver impact) to the at least one receive chain element caused by adjusting the transmit gain. In step 1106, the UE determines whether a receive timing adjustment has been received. If a receive timing adjustment has been received, in step 1108, the UE adjusts the time to adjust the transmit gain based on the adjusted receive timing. If a receive timing adjustment has not been received, in step 1110, the UE uses the determined time in step 1104 to adjust the transmit gain.

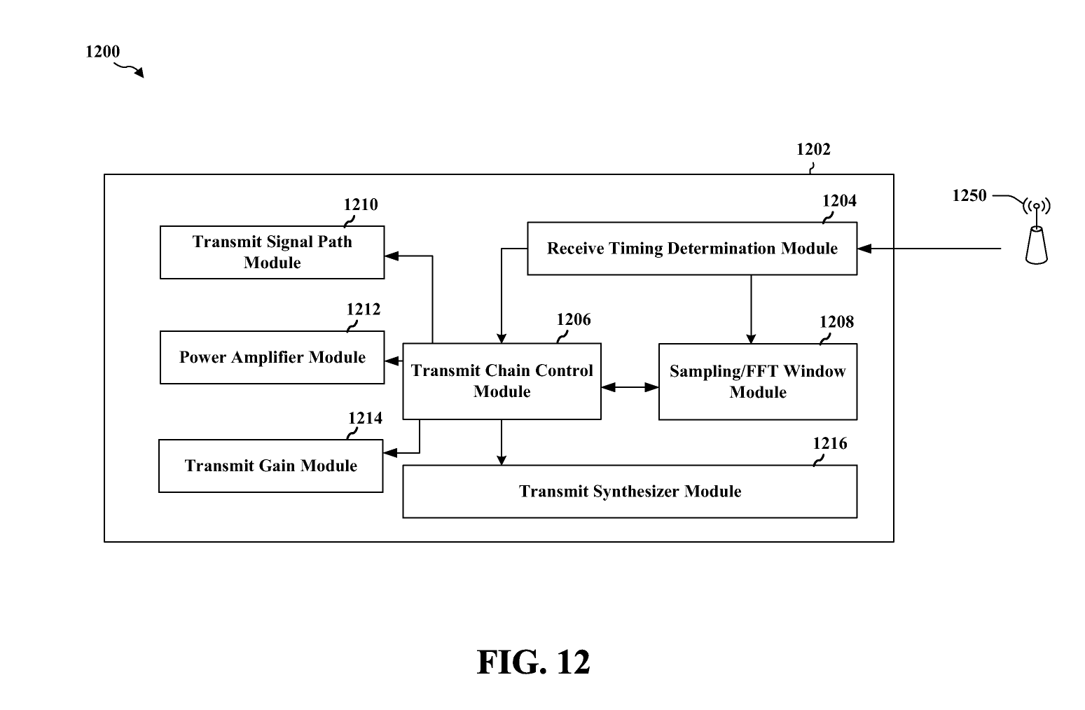

FIG. 12 is a conceptual data flow diagram 1200 illustrating the data flow between different modules/means/components in an exemplary apparatus 1202. The apparatus may be a UE. The apparatus includes a receive timing determination module 1204 that determines a receive timing for receiving through at least one receive chain element. The apparatus further includes a transmit chain control module 1206 that may determine a time to turn on/off at least one transmit chain element based on the determined receive timing and based on receiver impact (e.g., reducing receiver impact) to the at least one receive chain element caused by turning on/off the at least one transmit chain element. The transmit chain control module 1206 reduces receiver impact to the at least one receive chain element by turning on/off the at least one transmit chain element at the determined time. The at least one transmit chain element may include a transmit synthesizer module 1216, a transmit signal path module 1210, and a power amplifier module 1212. The transmit chain control module 1206 may reduce the receiver impact by reducing an effect on receive signal processing due to a transient voltage spike during a receive sampling window caused by turning on/off the at least one transmit chain element. The transmit chain control module 1206 may determine the time to turn on/off the at least one transmit chain element by delaying or advancing turning on/off the at least one transmit chain element in order to reduce the effect on the receive signal processing due to the transient voltage spike. Based on information from a sampling/FFT window module 1208, the transmit chain control module 1206 may delay/advance turning on/off the at least one transmit chain element based on a time of a first receive sampling window and a second receive sampling window (e.g., until a time between a first receive sampling window and a second receive sampling window). The transmit chain control module 1206 may turn on/off the at least one transmit chain element at approximately an interface between the first receive symbol and the second receive symbol, turn on/off the at least one transmit chain element approximately immediately after the first receive sampling window, or may turn on/off the at least one transmit chain element at a point such that a peak of a power supply transient occurs within a cyclic prefix or a guard interval between the first receive sampling window and the second receive sampling window. The point on which the at least one transmit chain element is turned on/off may be within a receive sampling window or between receive sampling windows depending on whether receive signal processing of signals received in the receive sampling windows is improved. The transmit chain control module 1206 may turn on/off each transmit chain element of the at least one transmit chain element with a time spacing of at least one symbol. The receiving timing determination module 1204 may receive a receive timing adjustment. When the receiving timing determination module 1204 receives a receive timing adjustment, the transmit chain control module 1206 adjusts the time to turn on/off at least one transmit chain element based on the adjusted receive timing.

The transmit chain control module 1206 may determine a time to adjust a transmit gain at the transmit gain module 1214 based on the determined receive timing and based on receiver impact (e.g., reducing receiver impact) to the at least one receive chain element caused by adjusting the transmit gain. The transmit chain control module 1206 may reduce receiver impact to the at least one receive chain element by adjusting the transmit gain at the determined time. The transmit chain control module 1206 may reduce receiver impact by reducing an effect on receive signal processing due to a transient voltage spike during a receive sampling window caused by increasing the transmit gain. The transmit chain control module 1206 may determine to increase the transmit gain. The transmit chain control module 1206 may determine the time to adjust the transmit gain by delaying increasing the transmit gain in order to reduce the effect on the receive signal processing due to the transient voltage spike. The transmit chain control module 1206 may delay the transmit gain increase until a time between a first receive sampling window and a second receive sampling window. The transmit chain control module 1206 may increase the transmit gain approximately immediately after the first receive sampling window. The first receive sampling window may be within a first receive symbol and the second receive sampling window may be within a second receive symbol. The transmit chain control module 1206 may increase the transmit gain at approximately an interface between the first receive symbol and the second receive symbol. The transmit chain control module 1206 may increase the transmit gain stepwise in consecutive symbols between corresponding receive sampling windows. The receiving timing determination module 1204 may receive a receive timing adjustment. When the receiving timing determination module 1204 receives a receive timing adjustment, the transmit chain control module 1206 adjusts the time to adjust the transmit gain at the transmit gain module 1214 based on the adjusted receive timing.

The apparatus may include additional modules that perform each of the steps of the algorithm in the aforementioned flow charts of FIGS. 8-11. As such, each step in the aforementioned flow charts of FIGS. 8-11 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof.

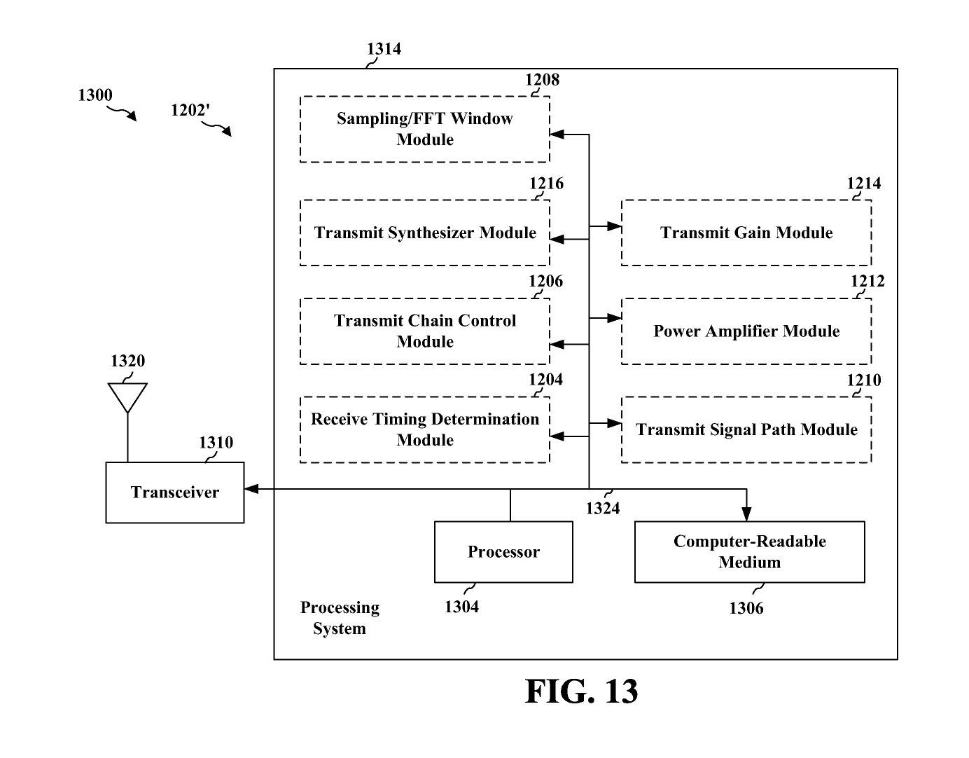

FIG. 13 is a diagram 1300 illustrating an example of a hardware implementation for an apparatus 1202′ employing a processing system 1314. The processing system 1314 may be implemented with a bus architecture, represented generally by the bus 1324. The bus 1324 may include any number of interconnecting buses and bridges depending on the specific application of the processing system 1314 and the overall design constraints. The bus 1324 links together various circuits including one or more processors and/or hardware modules, represented by the processor 1304, the modules 1204, 1206, 1208, 1210, 1212, 1214, 1216, and the computer-readable medium 1306. The bus 1324 may also link various other circuits such as timing sources, peripherals, voltage regulators, and power management circuits, which are well known in the art, and therefore, will not be described any further.

The processing system 1314 may be coupled to a transceiver 1310. The transceiver 1310 is coupled to one or more antennas 1320. The transceiver 1310 provides a means for communicating with various other apparatus over a transmission medium. The processing system 1314 includes a processor 1304 coupled to a computer-readable medium 1306. The processor 1304 is responsible for general processing, including the execution of software stored on the computer-readable medium 1306. The software, when executed by the processor 1304, causes the processing system 1314 to perform the various functions described supra for any particular apparatus. The computer-readable medium 1306 may also be used for storing data that is manipulated by the processor 1304 when executing software. The processing system further includes at least one of the modules 1204, 1206, 1208, 1210, 1212, 1214, and 1216. The modules may be software modules running in the processor 1304, resident/stored in the computer readable medium 1306, one or more hardware modules coupled to the processor 1304, or some combination thereof. The processing system 1314 may be a component of the UE 650 and may include the memory 660 and/or at least one of the TX processor 668, the RX processor 656, and the controller/processor 659.

In one configuration, the apparatus 1202/1202′ for wireless communication includes means for determining a receive timing for receiving through at least one receive chain element, means for determining a time to turn on/off at least one transmit chain element based on the determined receive timing and based on receiver impact to the at least one receive chain element caused by turning on/off the at least one transmit chain element, and means for reducing receiver impact to the at least one receive chain element by turning on/off the at least one transmit chain element at the determined time. The means for reducing the receiver impact may be configured to reduce an effect on receive signal processing due to a transient voltage spike during a receive sampling window caused by turning on/off the at least one transmit chain element. The means for determining the time to turn on/off the at least one transmit chain element may be configured to delay or to advance turning on/off the at least one transmit chain element based on the effect on the receive signal processing due to the transient voltage spike. The time to turn on/off the at least one transmit chain element may be delayed or advanced until a time between a first receive sampling window and a second receive sampling window. The time between the first receive sampling window and the second receive sampling window may include at least one of a cyclic prefix or a guard interval. The first receive sampling window may be within a first receive symbol and the second receive sampling window is within a second receive symbol. The time to turn on/off the at least one transmit chain element may be at approximately an interface between the first receive symbol and the second receive symbol. The time to turn on/off the at least one transmit chain element may be approximately immediately after the first receive sampling window. The time to turn on/off the at least one transmit chain element may be at a point such that a peak of a power supply transient occurs within a cyclic prefix or a guard interval between the first receive sampling window and the second receive sampling window. Each transmit chain element of the at least one transmit chain element may be turned on/off with a time spacing of at least one symbol. The apparatus may further include means for determining a time to adjust a transmit gain based on the determined receive timing, and means for reducing receiver impact to the at least one receive chain element by adjusting the transmit gain at the determined time to adjust the transmit gain. The apparatus may further include means for receiving a receive timing adjustment, and means for adjusting the time to turn on/off at least one transmit chain element based on the adjusted receive timing.

The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

In another configuration, the apparatus 1202/1202′ for wireless communication includes means for determining a receive timing for receiving through at least one receive chain element, means for determining a time to adjust a transmit gain based on the determined receive timing and based on receiver impact to the at least one receive chain element caused by adjusting the transmit gain, and means for reducing receiver impact to the at least one receive chain element by adjusting the transmit gain at the determined time. The means for reducing receiver impact may be configured to reduce an effect on receive signal processing due to a transient voltage spike during a receive sampling window caused by increasing the transmit gain. The apparatus may further include means for determining to increase the transmit gain. The means for determining the time to adjust the transmit gain may be configured to delay increasing the transmit gain based on the effect on the receive signal processing due to the transient voltage spike. The transmit gain increase may be delayed until a time between a first receive sampling window and a second receive sampling window. The apparatus may further include means for increasing the transmit gain at the time approximately immediately after the first receive sampling window. The first receive sampling window may be within a first receive symbol and the second receive sampling window may be within a second receive symbol, and the time to adjust the transmit gain may be at approximately an interface between the first receive symbol and the second receive symbol. The apparatus may further include means for increasing the transmit gain stepwise in consecutive symbols between corresponding receive sampling windows. The apparatus may further include means for receiving a receive timing adjustment, and means for adjusting the time to adjust the transmit gain based on the adjusted receive timing.

The aforementioned means may be one or more of the aforementioned modules of the apparatus 1202 and/or the processing system 1314 of the apparatus 1202′ configured to perform the functions recited by the aforementioned means. As described supra, the processing system 1314 may include the TX Processor 668, the RX Processor 656, and the controller/processor 659. As such, in one configuration, the aforementioned means may be the TX Processor 668, the RX Processor 656, and the controller/processor 659 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of a wireless communication device, comprising:
determining a receive timing for receiving through at least one receive chain element;
determining a time to turn on/off at least one transmit chain element based on the determined receive timing and based on receiver impact to the at least one receive chain element caused by turning on/off the at least one transmit chain element; and
reducing receiver impact to the at least one receive chain element by turning on/off the at least one transmit chain element at the determined time.

2. The method of claim 1, wherein the reducing the receiver impact comprises reducing an effect on receive signal processing due to a transient voltage spike during a receive sampling window caused by turning on/off the at least one transmit chain element.

3. The method of claim 2, wherein the determining the time to turn on/off the at least one transmit chain element comprises delaying or advancing turning on/off the at least one transmit chain element based on the effect on the receive signal processing due to the transient voltage spike.

4. The method of claim 3, wherein the time to turn on/off the at least one transmit chain element is delayed or advanced until a time between a first receive sampling window and a second receive sampling window.

5. The method of claim 4, wherein the time between the first receive sampling window and the second receive sampling window includes at least one of a cyclic prefix or a guard interval.

6. The method of claim 4, wherein the first receive sampling window is within a first receive symbol and the second receive sampling window is within a second receive symbol.

7. The method of claim 6, wherein the time to turn on/off the at least one transmit chain element is at approximately an interface between the first receive symbol and the second receive symbol.

8. The method of claim 4, wherein the time to turn on/off the at least one transmit chain element is approximately immediately after the first receive sampling window.

9. The method of claim 4, wherein the time to turn on/off the at least one transmit chain element is at a point such that a peak of a power supply transient occurs within a cyclic prefix or a guard interval between the first receive sampling window and the second receive sampling window.

10. The method of claim 1, wherein each transmit chain element of the at least one transmit chain element is turned on/off with a time spacing of at least one symbol.

11. The method of claim 1, further comprising:
determining a time to adjust a transmit gain based on the determined receive timing; and
reducing receiver impact to the at least one receive chain element by adjusting the transmit gain at the determined time to adjust the transmit gain.

12. The method of claim 1, further comprising:
receiving a receive timing adjustment; and
adjusting the time to turn on/off at least one transmit chain element based on the adjusted receive timing.

13. A method of a wireless communication device, comprising:
determining a receive timing for receiving through at least one receive chain element;
determining a time to adjust a transmit gain based on the determined receive timing and based on receiver impact to the at least one receive chain element caused by adjusting the transmit gain; and
reducing receiver impact to the at least one receive chain element by adjusting the transmit gain at the determined time.

14. The method of claim 13, wherein the reducing receiver impact comprises reducing an effect on receive signal processing due to a transient voltage spike during a receive sampling window caused by increasing the transmit gain.

15. The method of claim 14, further comprising determining to increase the transmit gain, wherein the determining the time to adjust the transmit gain comprises delaying increasing the transmit gain based on the effect on the receive signal processing due to the transient voltage spike.

16. The method of claim 15, wherein the transmit gain increase is delayed until a time between a first receive sampling window and a second receive sampling window.

17. The method of claim 16, further comprising increasing the transmit gain at the time approximately immediately after the first receive sampling window.

18. The method of claim 16, wherein the first receive sampling window is within a first receive symbol and the second receive sampling window is within a second receive symbol, and the time to adjust the transmit gain is at approximately an interface between the first receive symbol and the second receive symbol.

19. The method of claim 16, further comprising increasing the transmit gain stepwise in consecutive symbols between corresponding receive sampling windows.

20. The method of claim 13, further comprising:
receiving a receive timing adjustment; and
adjusting the time to adjust the transmit gain based on the adjusted receive timing.

21. An apparatus for wireless communication, comprising:
means for determining a receive timing for receiving through at least one receive chain element;
means for determining a time to turn on/off at least one transmit chain element based on the determined receive timing and based on receiver impact to the at least one receive chain element caused by turning on/off the at least one transmit chain element; and
means for reducing receiver impact to the at least one receive chain element by turning on/off the at least one transmit chain element at the determined time.

22. The apparatus of claim 21, wherein the means for reducing the receiver impact is configured to reduce an effect on receive signal processing due to a transient voltage spike during a receive sampling window caused by turning on/off the at least one transmit chain element.

23. The apparatus of claim 22, wherein the means for determining the time to turn on/off the at least one transmit chain element is configured to delay or to advance turning on/off the at least one transmit chain element based on the effect on the receive signal processing due to the transient voltage spike.

24. The apparatus of claim 23, wherein the time to turn on/off the at least one transmit chain element is delayed or advanced until a time between a first receive sampling window and a second receive sampling window.

25. The apparatus of claim 24, wherein the time between the first receive sampling window and the second receive sampling window includes at least one of a cyclic prefix or a guard interval.

26. The apparatus of claim 24, wherein the first receive sampling window is within a first receive symbol and the second receive sampling window is within a second receive symbol.

27. The apparatus of claim 26, wherein the time to turn on/off the at least one transmit chain element is at approximately an interface between the first receive symbol and the second receive symbol.

28. The apparatus of claim 24, wherein the time to turn on/off the at least one transmit chain element is approximately immediately after the first receive sampling window.

29. The apparatus of claim 24, wherein the time to turn on/off the at least one transmit chain element is at a point such that a peak of a power supply transient occurs within a cyclic prefix or a guard interval between the first receive sampling window and the second receive sampling window.

30. The apparatus of claim 21, wherein each transmit chain element of the at least one transmit chain element is turned on/off with a time spacing of at least one symbol.

31. The apparatus of claim 21, further comprising:
means for determining a time to adjust a transmit gain based on the determined receive timing; and
means for reducing receiver impact to the at least one receive chain element by adjusting the transmit gain at the determined time to adjust the transmit gain.

32. The apparatus of claim 21, further comprising:
means for receiving a receive timing adjustment; and
means for adjusting the time to turn on/off at least one transmit chain element based on the adjusted receive timing.

33. An apparatus for wireless communication, comprising:
means for determining a receive timing for receiving through at least one receive chain element;
means for determining a time to adjust a transmit gain based on the determined receive timing and based on receiver impact to the at least one receive chain element caused by adjusting the transmit gain; and
means for reducing receiver impact to the at least one receive chain element by adjusting the transmit gain at the determined time.

34. The apparatus of claim 33, wherein the means for reducing receiver impact is configured to reduce an effect on receive signal processing due to a transient voltage spike during a receive sampling window caused by increasing the transmit gain.

35. The apparatus of claim 34, further comprising means for determining to increase the transmit gain, wherein the means for determining the time to adjust the transmit gain is configured to delay increasing the transmit gain based on the effect on the receive signal processing due to the transient voltage spike.

36. The apparatus of claim 35, wherein the transmit gain increase is delayed until a time between a first receive sampling window and a second receive sampling window.

37. The apparatus of claim 36, further comprising means for increasing the transmit gain at the time approximately immediately after the first receive sampling window.

38. The apparatus of claim 36, wherein the first receive sampling window is within a first receive symbol and the second receive sampling window is within a second receive symbol, and the time to adjust the transmit gain is at approximately an interface between the first receive symbol and the second receive symbol.

39. The apparatus of claim 36, further comprising means for increasing the transmit gain stepwise in consecutive symbols between corresponding receive sampling windows.

40. The apparatus of claim 33, further comprising:
means for receiving a receive timing adjustment; and
means for adjusting the time to adjust the transmit gain based on the adjusted receive timing.

41. An apparatus for wireless communication, comprising:
a processing system configured to:
determine a receive timing for receiving through at least one receive chain element;
determine a time to turn on/off at least one transmit chain element based on the determined receive timing and based on receiver impact to the at least one receive chain element caused by turning on/off the at least one transmit chain element; and
reduce receiver impact to the at least one receive chain element by turning on/off the at least one transmit chain element at the determined time.

42. The apparatus of claim 41, wherein the processing system is configured to reduce the receiver impact by reducing an effect on receive signal processing due to a transient voltage spike during a receive sampling window caused by turning on/off the at least one transmit chain element.

43. The apparatus of claim 42, wherein the processing system is configured to determine the time to turn on/off the at least one transmit chain element by delaying or advancing turning on/off the at least one transmit chain element based on the effect on the receive signal processing due to the transient voltage spike.

44. The apparatus of claim 43, wherein the time to turn on/off the at least one transmit chain element is delayed or advanced until a time between a first receive sampling window and a second receive sampling window.

45. The apparatus of claim 44, wherein the time between the first receive sampling window and the second receive sampling window includes at least one of a cyclic prefix or a guard interval.

46. The apparatus of claim 44, wherein the first receive sampling window is within a first receive symbol and the second receive sampling window is within a second receive symbol.

47. The apparatus of claim 46, wherein the time to turn on/off the at least one transmit chain element is at approximately an interface between the first receive symbol and the second receive symbol.

48. The apparatus of claim 44, wherein the time to turn on/off the at least one transmit chain element is approximately immediately after the first receive sampling window.

49. The apparatus of claim 44, wherein the time to turn on/off the at least one transmit chain element is at a point such that a peak of a power supply transient occurs within a cyclic prefix or a guard interval between the first receive sampling window and the second receive sampling window.

50. The apparatus of claim 41, wherein each transmit chain element of the at least one transmit chain element is turned on/off with a time spacing of at least one symbol.

51. The apparatus of claim 41, wherein the processing system is further configured to:
determine a time to adjust a transmit gain based on the determined receive timing; and
reduce receiver impact to the at least one receive chain element by adjusting the transmit gain at the determined time to adjust the transmit gain.

52. The apparatus of claim 41, wherein the processing system is further configured to:
receive a receive timing adjustment; and
adjust the time to turn on/off at least one transmit chain element based on the adjusted receive timing.

53. An apparatus for wireless communication, comprising:
a processing system configured to:
determine a receive timing for receiving through at least one receive chain element;
determine a time to adjust a transmit gain based on the determined receive timing and based on receiver impact to the at least one receive chain element caused by adjusting the transmit gain; and
reduce receiver impact to the at least one receive chain element by adjusting the transmit gain at the determined time.

54. The apparatus of claim 53, wherein the processing system is configured to reduce receiver impact by reducing an effect on receive signal processing due to a transient voltage spike during a receive sampling window caused by increasing the transmit gain.

55. The apparatus of claim 54, wherein the processing system is further configured to determine to increase the transmit gain, wherein the processing system is configured to determine the time to adjust the transmit gain by delaying increasing the transmit gain based on the effect on the receive signal processing due to the transient voltage spike.

56. The apparatus of claim 55, wherein the transmit gain increase is delayed until a time between a first receive sampling window and a second receive sampling window.

57. The apparatus of claim 56, wherein the processing system is further configured to increase the transmit gain at the time approximately immediately after the first receive sampling window.

58. The apparatus of claim 56, wherein the first receive sampling window is within a first receive symbol and the second receive sampling window is within a second receive symbol, and the time to adjust the transmit gain is at approximately an interface between the first receive symbol and the second receive symbol.

59. The apparatus of claim 56, wherein the processing system is further configured to increase the transmit gain stepwise in consecutive symbols between corresponding receive sampling windows.

60. The apparatus of claim 53, wherein the processing system is further configured to:
receive a receive timing adjustment; and
adjust the time to adjust the transmit gain based on the adjusted receive timing.

61. A computer program product in a wireless communication device, comprising:
a computer-readable medium comprising code for:
determining a receive timing for receiving through at least one receive chain element;
determining a time to turn on/off at least one transmit chain element based on the determined receive timing and based on receiver impact to the at least one receive chain element caused by turning on/off the at least one transmit chain element; and
reducing receiver impact to the at least one receive chain element by turning on/off the at least one transmit chain element at the determined time.

62. A computer program product in a wireless communication device, comprising:
a computer-readable medium comprising code for:
determining a receive timing for receiving through at least one receive chain element;
determining a time to adjust a transmit gain based on the determined receive timing and based on receiver impact to the at least one receive chain element caused by adjusting the transmit gain; and
reducing receiver impact to the at least one receive chain element by adjusting the transmit gain at the determined time.
